(19) United States
(12) Patent Application Publication
(10) Pub. No.: US 2023/0073549 A1
(43) Pub. Date: Mar. 9, 2023

(54) METHOD FOR ANALYSING A WELD DURING LASER WELDING OF WORKPIECES

(71) Applicant: Precitec GmbH & Co. KG, Gaggenau (DE)

(72) Inventors: Jens Reiser, Rheinstetten (DE); Lutz König, Iffezheim (DE); Erich Schauer, Kuppenheim (DE); Thorsten Lorenz, Iffezheim (DE); Jonas Nolte, Karlsruhe (DE); Alexis Donke, Pforzheim (DE); Sascha Grau, Karlsruhe (DE); Rüdiger Moser, Malsch (DE); Wei Quang Duong, Rastatt (DE); Matthias Strebel, Gaggenau (DE); Birmanns Stefan, Rheinau (CH)

(21) Appl. No.: 17/801,157

(22) PCT Filed: Feb. 18, 2021
(86) PCT No.: PCT/EP2021/053993

§ 371 Date: Aug. 19, 2022

(30) Foreign Application Priority Data
Feb. 20, 2020 (DE) 10 2020 104 462.3

(51) Int. Cl. B23K 31/12; B23K 26/03; B23K 26/244; H01M 50/516

(52) U.S. Cl. CPC B23K 31/125; B23K 26/03; B23K 26/244; H01M 50/516; B23K 2103/10

(57) ABSTRACT

A method of analyzing a welded connection during laser welding of workpieces includes acquiring a first measurement signal for a process radiation generated during laser welding, acquiring a second measurement signal for a laser radiation reflected by the workpieces, determining whether there is a gap between the workpieces based on the first measurement signal, and when it is determined that there is a gap, determining based on the second measurement signal whether there is a welded connection.

### CROSS-REFERENCE TO RELATED APPLICATIONS

This application is the U.S. National Stage of PCT/EP2021/053993 filed on Feb. 18, 2021, which claims priority to German Patent Application 102020104462.3 filed on Feb. 20, 2020, the entire content of both are incorporated herein by reference in their entirety.

### FIELD OF THE INVENTION

The present invention relates to a method of analyzing a welded connection during the laser welding of workpieces, in particular during the laser welding process.

### BACKGROUND OF THE INVENTION

In a laser machining system for machining a workpiece using a laser beam, the laser beam emerging from a laser light source or from one end of a laser optical fiber is focused or collimated onto the workpiece to be machined by means of a beam guiding and focusing optics. Machining may comprise laser welding, for example. The laser machining system may include a laser machining device, for example a laser machining head, in particular a laser welding head. Particularly when laser welding a workpiece, it is important to continuously monitor the welding process to ensure the quality of machining. This includes the detection of machining defects.

A machining process is typically monitored by acquiring and analyzing various parameters of a process radiation, also referred to as a process beam, process light or process emission. These include, for example, plasma radiation from workpiece surfaces during machining, process emissions in the infrared range of light such as thermal radiation, or process emissions in the visible range of light. Then, an assessment is made, wherein the corresponding measurement signals are checked to determine whether certain conditions are met. When one or more measurement signals meet previously defined conditions during machining, a defect signal is output. Accordingly, a machined workpiece may be marked as “good” or “good part” (i.e. suitable for further machining or sale) or as “bad” or “bad part” (i.e. scrap). Continuous monitoring of a machining process is typically performed in real time while the machining process is being carried out and is therefore also referred to as online process monitoring or in-line process monitoring.

The application DE 10 2019 122 047 describes a sensor module for monitoring laser welding processes, the sensor module including a plurality of detectors or sensors that detect various parameters of the process radiation and output them as a measurement signal.

Batteries play a central role in the field of electromobility. Individual battery cells, also called “battery cells”, are connected to each other, i.e. contacted. A combination of a plurality of battery cells is referred to as a “battery module”. The connection is usually made by laser welding. The conductors of the battery cells are connected to one another by laser welding, typically in a lap joint. For example, the weld seams have a so-called “I-seam” geometry. Materials are usually aluminum and copper. Typical connections or combinations of materials are copper-copper, aluminum-aluminum and copper-aluminum. When connecting battery cells to battery modules, and thus for a successful module construction, it is essential that there is an electrical contact between the connected workpieces, i.e. that current can flow between the connected workpieces or via the weld seam. Only then the contact is successful.

During laser welding, typical defect patterns may occur, especially in lap joints with I-seams. This includes a gap between the workpieces. This defect may be tolerated if there is a welded connection, i.e. the gap is bridged by melted material of the workpieces, i.e. if there is still electrical contact between the workpieces to be welded despite the gap. This is also referred to as “gap bridging welding” or “gap with (electrical) contact”. Another typical defect pattern is referred to as a “false friend”. There is a gap between the joined workpieces, the gap is not bridged and there is therefore no (electrical) contact between the workpieces. This is also known as “welding without gap bridging” or “gap without (electrical) contact”. That is, a gap between the workpieces should not be present, if possible, or be as small as possible

In a top view, in particular during an inspection after laser welding has been carried out, it is not possible to distinguish visually whether there is a proper weld, i.e. a welded connection without a gap, also referred to as a “good weld” or “weld with zero gap”, or whether there is a welded connection with a gap but with gap bridging, i.e. a welded joint with a gap, or a weld with a gap but without gap bridging. Currently there is no way to detect a false friend during the welding process.

### SUMMARY OF THE INVENTION

It is an object of the present invention to analyze or assess a welded connection between workpieces simply and quickly during laser welding.

It is an object of the present invention, during laser welding, to enable a simple and quick distinction between a weld without a gap and a weld with a gap.

In particular, it is an object of the present invention to recognize, in the case of a weld with a gap between the workpieces, whether a gap with gap bridging, i.e. with electrical contact between the workpieces, or a gap without connection, i.e. without electrical contact between the workpieces, is present.

It is a further object of the present invention to enable real-time analysis or discrimination, particularly during the laser welding process of the welded connection.

These objects are achieved by the subject matter of the independent claim. Advantageous refinements and developments are also disclosed.

The invention is based on the idea of detecting and suitably evaluating measurement signals, in particular during the laser welding process, based on the process radiation produced during the laser welding of welded connections and laser radiation reflected back in order to thereby analyze and distinguish welds or welded connections. The measurement signals may be detected by sensors, in particular by photodiodes.

According to an aspect of the present invention, a method of analyzing or assessing a welded connection during laser welding of workpieces is provided, said method comprising the steps of: acquiring a first measurement signal of a process radiation generated during laser welding; acquiring a second measurement signal of a laser radiation reflected by the workpieces; determining whether there is a gap between the joined workpieces based on the first measurement signal; and, when it is determined that there is a gap, determining whether there is a welded connection or gap bridging based on the second measurement signal. Here, the reflected radiation may include at least one of: reflected laser radiation of the (machining) laser beam, reflected LED radiation or reflected LED light, and reflected pilot laser radiation. The method may further comprise: irradiating with LED radiation or illuminating with LED light, in particular illuminating a current machining position or illuminating an area around a current point of incidence of a (machining) laser beam. The method may further comprise: radiating a pilot laser beam, in particular radiating it into a current machining position or into an area around a current point of incidence of a (machining) laser beam. The reflected radiation or the pilot laser beam or the LED light may have any desired wavelength, in particular a wavelength in the infrared range or in the visible green or blue range. In particular, an LED light source or a pilot laser beam source may have a wavelength of approximately 630 nm or approximately 530 nm, for example. Preferably, at least part of a beam path of an LED light or pilot laser beam radiated into a machining area extends coaxially to the beam path of a machining laser beam.

The method according to the invention therefore makes it possible to detect whether there is a gap between the joined workpieces. Furthermore, the method according to the invention makes it possible to recognize whether there is a welded connection. Welded connection may refer to an electrical and/or mechanical (i.e. physical) welded connection, i.e. there is an electrical or mechanical contact between the workpieces. A welded connection exists when there is no gap between the joined workpieces (so-called zero gap), or when there is a gap but it is bridged (gap with gap bridging). There is no welded connection when a gap is not bridged. Accordingly, the method may be used to analyze a welded electrical connection, in particular to detect a lack of electrical contact between joined workpieces, e.g. when contacting battery cells to battery modules. Thus, according to the invention, good welds or welds without a gap can be distinguished from welds with a gap and welds with a gap can be differentiated into those with gap bridging and those without gap bridging.

It is also possible to classify the weld into: (i) a proper weld, i.e. a weld without a gap, also referred to as a “good weld” or a “zero gap weld”, (ii) a weld with a gap and gap bridging, so that there is (electrical or mechanical) contact between the joined workpieces, and (iii) a weld with a gap but without gap bridging, so that there is no (electrical or mechanical) contact between the joined workpieces. The classification is preferably carried out during laser welding, i.e. during the laser welding process for creating the weld.

Preferably, the workpieces joined by the laser welding are evaluated or marked as “good” or “good part” when it is determined that a welded connection exists, and evaluated or marked as “bad” or “bad part” when it is determined that a welded connection does not exist. Based thereon, the laser welding may also be open-loop or closed-loop controlled. For example, machining parameters such as the laser power supplied, the distance between a laser machining device and the workpieces, a focus position and/or focal position of a laser beam used for laser welding, etc., may be adjusted or controlled, in particular in real time. The method may further include outputting an error for workpieces when it is determined that there is no welded connection and/or outputting a warning for workpieces when it is determined that a gap, in particular a gap with a gap width greater than a predetermined value, exists.

In an exemplary embodiment, the determination based on the second measurement signal as to whether there is a welded connection or a gap bridging can only be carried out when it was previously determined that there is a gap.

At least one step of the method according to the invention may be carried out during the laser welding of the weld, in particular in real time. Accordingly, the method according to the invention may be referred to as an “in-line method”. The first and/or second measurement signal is/are preferably acquired during the laser welding. Likewise, the determination of whether there is a gap and/or the determination of whether there is a welded connection or a gap bridging may be carried out during the laser welding. Preferably, the entire method according to the invention is carried out during the laser welding.

The method according to the invention may be used in particular for laser welding in lap or parallel joints.

The first measurement signal and/or second measurement signal may be based on a measurement of a radiation intensity. In particular, the first measurement signal may be based on a measurement of a radiation intensity of the process radiation and/or the second measurement signal may be based on a measurement of a radiation intensity of the reflected laser radiation. The process radiation generated during laser welding may include thermal radiation in the infrared wavelength range of light and/or plasma radiation in the visible range of light.

The first measurement signal may be acquired in a first wavelength range above the wavelength of a laser beam used for laser welding and/or in a second wavelength range below the wavelength of a laser beam used for laser welding. Alternatively or additionally, the first measurement signal may be acquired in a second wavelength range below the wavelength of a laser beam used for laser welding and/or below the wavelength of the reflected radiation. The first wavelength range may correspond to an infrared wavelength range of the light. In other words, the first measurement signal in the first wavelength range may correspond to thermal radiation. The second wavelength range may correspond to a wavelength range of visible light. In other words, the first measurement signal in the second wavelength range may correspond to a plasma radiation. The first measurement signal in the first wavelength range may be acquired by at least one first photodiode with spectral sensitivity in the first wavelength range. The first measurement signal in the second wavelength range may be acquired by at least one second photodiode with spectral sensitivity in the second wavelength range. In other words, the first measurement signal is preferably acquired separately in the first wavelength range and in the second wavelength range or acquired by at least one photodiode each.

The second measurement signal or the reflected radiation, in particular the reflected laser radiation, or the laser beam used for the laser welding or the radiated pilot laser beam or the radiated LED light may be in the infrared, blue or green wavelength range or spectral range. In other words, an infrared laser beam source may be used as a beam source for the (machining) laser beam or for the pilot laser beam. Alternatively, a laser beam source of the laser beam used for laser welding or of the pilot laser beam may emit in the green or blue spectral or wavelength range.

That is, the first measurement signal may be based on a detection of the radiation intensity of the process radiation in a first wavelength range, in particular in an infrared range, in order to detect thermal radiation, and/or based on a detection of the radiation intensity of the process radiation in a second wavelength range, in particular in a visible range in order to detect plasma radiation. The first measurement signal acquired in the first wavelength range may accordingly be referred to as a “thermal signal”. The first measurement signal acquired in the second wavelength range may accordingly be referred to as a “plasma signal”.

The process radiation generated during laser welding may be acquired by at least one (first and/or second) photodiode as a first measurement signal and/or the reflected radiation may be acquired by at least one (third) photodiode as a second measurement signal. The third photodiode may have a spectral sensitivity in the wavelength range of the laser used for laser welding. In other words, the first and second measurement signals are preferably acquired separated or acquired by at least one photodiode each. The photodiodes preferably have spectral sensitivities that differ from one another.

Determining whether there is a gap between the workpieces may include determining a gap width based on the first measurement signal. In this case, it may be determined that there is a gap when the gap width is larger than a predetermined gap width limit value. The gap width limit value may be between 50 μm and 200 μm, in particular 100 μm and 175 μm, or it may be 50 μm, 100 μm or 150 μm.

For example, the gap width may be defined as the shortest distance between the joined workpieces adjacent to, but outside of, the weld or a weld seam. For example, the gap width, for example in the case of a lap joint or a parallel joint, may be defined as the shortest distance between the workpiece surfaces arranged opposite one another.

Determining whether there is a gap between the workpieces may include determining whether the first measurement signal is below a reference value or a reference curve. When the first measurement signal is acquired for the first wavelength range and the second wavelength range, it may be determined whether the first measurement signal of the first wavelength range is below a first reference value or reference curve and whether the first measurement signal of the second wavelength range is below a second reference value or reference curve. The reference curve may be a lower envelope. In this case, it may be determined that there is a gap between the workpieces when the measurement signal is below the reference value or the reference curve. Determining whether there is a gap between the workpieces may further include determining whether the first measurement signal falls below a reference value or a reference curve. In this case, it may be determined that there is a gap between the workpieces when the measurement signal falls below the reference value or reference curve.

Determining whether there is a gap between the workpieces may include taking a first integral over the first measurement signal. In this case, it may be determined that there is a gap between the workpieces when the first integral falls below a predetermined first integral limit value. The first integral may be taken over at least one region of the first measurement signal.

Alternatively or additionally, determining whether there is a gap between the workpieces may include taking a first mean value over the first measurement signal. In this case, it may be determined that there is a gap between the workpieces when the first mean value falls below a predetermined first mean value limit. The first mean value may be taken over at least one region of the first measurement signal.

Alternatively or additionally, determining whether there is a gap between the workpieces may include determining a first outlier frequency of the first measurement signal. In this case, it may be determined that there is a gap between the workpieces when the first outlier frequency of the first measurement signal exceeds a predetermined first outlier limit value. The first outlier frequency may be taken over at least one region of the first measurement signal.

When the first measurement signal is acquired for the first wavelength range and the second wavelength range, respectively, it may be used to determine whether there is a gap between the workpieces, to take a first integral over the first measurement signal acquired in the first wavelength range, i.e. the thermal signal, and to form a second integral over the first measurement signal acquired in the second wavelength range, i.e. the plasma signal, wherein it is determined that there is a gap between the workpieces when the first integral falls below a predetermined first integral limit value and/or when the second integral falls below a predetermined second integral limit value.

When the first measurement signal is acquired for the first wavelength range and the second wavelength range, respectively, it may be used to determine whether there is a gap between the workpieces, to take a first mean value over the first measurement signal acquired in the first wavelength range, i.e. the thermal signal, and to form a second mean value over the first measurement signal acquired in the second wavelength range, i.e. the plasma signal, wherein it is determined that there is a gap between the workpieces when the first mean value falls below a predetermined first mean value limit value and/or when the second mean value falls below a predetermined second mean value limit value.

When the first measurement signal is acquired for the first wavelength range and the second wavelength range, respectively, determining whether there is a gap between the workpieces may comprise determining a first outlier frequency of the first measurement signal acquired in the first wavelength range, i.e. the thermal signal, and calculating a second outlier frequency of the first measurement signal acquired in the second wavelength range, i.e. the plasma signal. In this case, it may be determined that there is a gap between the workpieces when the first outlier frequency exceeds a predetermined first outlier limit value and/or when the second outlier frequency exceeds a predetermined second outlier limit value.

The outlier frequency may be defined as a frequency or number of values of the first measurement signal that lie outside of predefined envelope curves for the first measurement signal. The frequency of outliers may be specified as a percentage based on a considered and/or predetermined time interval or measurement interval or on a considered and/or predetermined region of the first measurement signal. Alternatively, the outlier frequency may be specified in absolute terms. When the first measurement signal is acquired in the first and in the second wavelength range, the first outlier frequency may be determined separately based on a frequency or number of values of the first measurement signal in the first wavelength range, which are outside of predetermined first envelopes for the first measurement signal, and the second outlier frequency may be determined separately based on a frequency or number of values of the first measurement signal in the second wavelength range, which are outside of predetermined second envelopes for the first measurement signal.

The determination of whether there is a welded connection or a gap bridging may be determined based on a noise of the second measurement signal. The noise may be determined as a deviation from a mean value of the second measurement signal, e.g. in a predetermined time interval or measurement interval or in a considered and/or predetermined range of the second measurement signal, and optionally provided with a gain factor. The noise may also be referred to as the “noise signal” or as the “noise component” of the second measurement signal.

It may be determined that there is no welded connection or gap bridging when an outlier frequency of the noise of the second measurement signal exceeds a predetermined first noise limit value and/or when an integral over the noise of the second measurement signal exceeds a predetermined second noise limit value.

The outlier frequency in the noise of the second measurement signal may be defined as a frequency or number of noise values that lie outside of predefined envelope curves and/or predefined tolerance ranges for the noise. The outlier frequency may be specified as a percentage based on a considered time interval and/or measurement interval or on a range of the second measurement signal. Alternatively, the outlier frequency may be specified in absolute terms.

At least one of the workpieces may include or consist of aluminum and/or copper and/or nickel. In particular, one of the workpieces may consist of aluminum and another one of the workpieces may comprise copper, the latter optionally being coatable with nickel (e.g. layer thickness of 8 μm). The coating may be applied galvanically.

At least one of the workpieces may have a thickness of 0.10 mm to 0.50 mm, preferably a thickness of 0.15 mm to 0.35 mm, particularly preferably a thickness of 0.20 mm to 0.30 mm.

The workpieces may be or may include sheet metal or a diverter. One of the workpieces may include a battery, a battery module and/or a battery cell, and/or another one of the workpieces may include a diverter. A welded electrical contact between the conductor and the battery cell may be analyzed as a weld.

According to a further aspect of the present disclosure, a method for laser welding a first workpiece and a second workpiece is provided, comprising the steps of: arranging the workpieces in such a way that a first surface of the first workpiece and a first surface of the second workpiece lie on top of one another or are in contact with one another; laser welding the workpieces to form a welded connection between the workpieces by radiating a laser beam onto a second surface of the first workpiece, the second surface of the first workpiece being opposite the first surface of the first workpiece, and/or by radiating a laser beam onto a second surface of the second workpiece, the second surface of the second workpiece being opposite the first surface of the second workpiece; and performing the method of analyzing the weld connection described herein.

The first surface and the second surface of the first workpiece and/or the first surface and the second surface of the second workpiece may be formed in parallel to one another. The first workpiece and/or the second workpiece may be configured as a metal sheet or diverter or may comprise a metal sheet or diverter. The first and second surfaces of the workpieces may be referred to as the main surfaces of the workpieces.

The first surfaces of the workpieces may touch in at least one region. In another region, there may be a gap between the workpieces.

The workpieces may be arranged with the aim that the gap between the workpieces does not exist or is as small as possible. The workpieces may be arranged in a lap joint or parallel joint.

The methods according to the invention may be carried out by a laser machining system which includes a laser machining device for machining a workpiece using a laser beam, in particular a laser welding head, and a sensor module. The laser machining device may include a beam splitter for coupling process radiation out of the beam path of the laser beam. The laser machining device may include an optical output for coupling out process radiation, and the sensor module may include an optical input for coupling in the process radiation emerging from the laser machining device. The sensor module comprises at least one detector for detecting the process radiation and for detecting the reflected radiation, in this example the reflected laser radiation of the (machining) laser beam. In an exemplary embodiment, the laser machining system may include an LED lighting unit for radiating LED light. In this case, the reflected radiation detected by the sensor module includes reflected LED radiation or reflected LED light. In a further exemplary embodiment, the laser machining system may include a pilot laser unit for radiating a pilot laser beam. In this case, the reflected radiation detected by the sensor module includes reflected pilot laser radiation or reflected LED light. The pilot laser unit may include a pilot laser beam source. The laser machining system may include a pilot laser beam source, e.g. for generating a pilot laser beam having a wavelength of about 630 nm or about 530 nm. Alternatively or additionally, the laser machining system may include an LED source for generating LED light. The LED light may be coupled into a beam path of the machining laser beam or into the laser machining device, e.g. by means of a beam splitter. The sensor module may be coupled to the laser machining device. The at least one detector may be configured to detect at least one beam parameter of the process radiation, in particular an intensity in a specific wavelength range. The at least one detector may be further configured to output a measurement signal based on the detection. The detectors may comprise a photodiode and/or a photodiode array and/or a camera, for example a CMOS or CCD-based camera. The sensor module may include a number of detectors which are each configured to detect the process radiation at different wavelengths or in different wavelength ranges. The laser machining system may further include a control unit. The control unit may be configured to receive analog measurement signals from the at least one detector. The control unit may be configured to carry out a method according to one of the embodiments listed in this disclosure in order to analyze welded connections. The control unit may be further configured to open-loop or closed-loop control the laser machining system, in particular the laser machining device, as described above based on a result of the analysis.

The respective detectors may only be sensitive at a specific wavelength or in a specific wavelength range. For example, a first detector may be sensitive in the visible range of light, a second detector may be sensitive in an infrared range, and/or a third detector may be sensitive in a laser emission wavelength range of the laser machining device. The detectors may therefore be configured in such a way that they are sensitive in different wavelength ranges. According to an exemplary embodiment, the sensor module comprises a first detector with a photodiode that is sensitive in the visible spectrum of light in order to detect plasma process emissions or plasma radiation, a second detector with a photodiode that is sensitive in the infrared wavelength range in order to detect process emissions or thermal radiation, and a third detector with a photodiode that is sensitive in the laser emission wavelength range to detect back reflections of the laser of the laser machining device. Accordingly, the method according to the invention may be carried out with the laser machining system. In particular, the first measurement signal, in particular the thermal signal and/or the plasma signal, and the second measurement signal may be acquired by the sensor module described.

According to the present disclosure, a method for detecting gaps and in particular for distinguishing between gaps with connection or with contact and gaps without connection or without contact is provided, in particular using sensors such as photodiodes.

### BRIEF DESCRIPTION OF THE DRAWINGS

The invention is described in detail below with reference to figures.

FIG. 1 shows a schematic diagram of a laser machining system for machining a workpiece by means of a laser beam for performing a method of analyzing a welded connection according to embodiments of the present disclosure;

FIG. 2 shows a detailed schematic diagram of a sensor module of the laser machining system shown in FIG. 1;

FIG. 3 shows a flowchart of a method of analyzing a welded connection during laser welding according to embodiments of the present disclosure;

FIGS. 4A-4D show welded connections analyzed with a method of analyzing a welded connection during laser welding of workpieces according to embodiments of the present disclosure;

FIGS. 5A-5D show examples of time curves of measurement signals acquired by a method of analyzing a welded connection during laser welding of workpieces according to embodiments; and

FIG. 6 shows, by way of example, a determination of gap widths by a method of analyzing a welded connection during laser welding of workpieces according to embodiments of the present disclosure.

### DETAILED DESCRIPTION OF THE INVENTION

Unless otherwise noted, the same reference symbols are used in the following for the same elements and elements with equivalent effect.

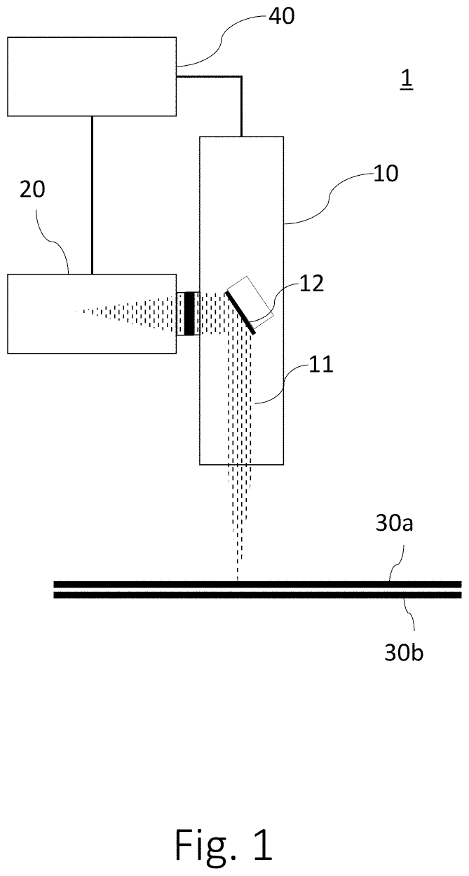

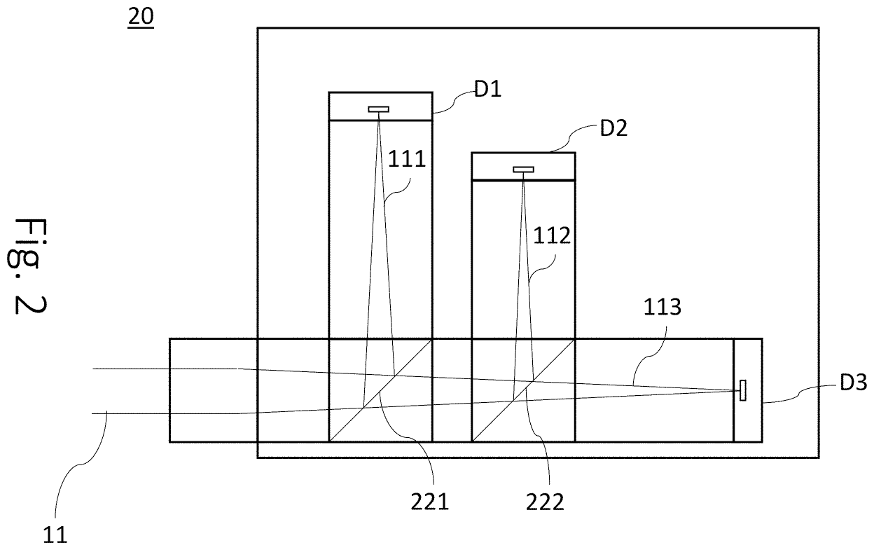

FIG. 1 shows a schematic diagram of a laser machining system for machining a workpiece by means of a (machining) laser beam according to embodiments of the present disclosure. FIG. 2 shows a detailed schematic diagram of the sensor module of the laser machining system shown in FIG. 1.

The laser machining system 1 comprises a laser machining device 10, a sensor module 20, and a control unit 40.

The laser machining device 10, which may be configured, for example, as a laser machining head, in particular as a laser welding head, is configured to focus or collimate a laser beam (not shown) by means of beam guiding and focusing optics (not shown) onto the workpieces 30a, 30b to be machined, in order thereby to carry out machining or a machining process. Machining may in particular comprise laser welding. During machining, process radiation 11, which enters the laser machining device 10 and is coupled out of the beam path of the laser beam by a beam splitter 12, is generated. The process radiation is guided into the sensor module 20 and is incident on at least one detector D1, D2, D3 there.

For machining, the workpieces 30a, 30b may be arranged in such a way that they overlap. The workpieces 30a, 30b may in particular be arranged in a parallel joint or lap joint.

For example, as in FIG. 1, a lower surface of the workpiece 30a is opposite an upper surface of the workpiece 30b and the laser beam is radiated onto an upper surface of the workpiece 30a. The upper surfaces and the lower surfaces of the workpieces 30a, 30b may also be referred to as the main faces or main surfaces of the workpieces 30a, 30b.

As shown, the laser beam is radiated onto the upper surface or the upper main surface of the workpiece 30a, preferably substantially perpendicular to the main surfaces of the workpieces 30a, 30b. Accordingly, the laser beam is not radiated onto the edges or edges or in parallel to the main surfaces of the workpieces 30a, 30b.

Accordingly, the resulting process radiation 11 is emitted from the upper surface or from the upper main surface of the workpiece 30a. The process radiation 11 is thus preferably acquired from the upper surface of the workpiece 30a. Likewise, reflected radiation is preferably acquired from the upper surface of workpiece 30a. In an exemplary embodiment that is not shown, the laser machining system may include an LED lighting unit for radiating LED light into a machining area on the workpiece. In this case, the reflected radiation detected by the sensor module includes reflected LED radiation or reflected LED light. In a further exemplary embodiment that is not shown, the laser machining system may include a pilot laser unit for radiating a pilot laser beam into a machining area on the workpiece. In this case, the reflected radiation detected by the sensor module includes reflected pilot laser radiation or reflected LED light. The pilot laser unit may include a pilot laser beam source.

In particular for laser welding of the workpieces 30a, 30b, the workpieces 30a, 30b should be arranged in a lap or parallel joint such that there is no gap between the workpieces 30a, 30b arranged in this way or that the gap is as small as possible. As shown, there is an (undesirable) gap between the workpieces 30a, 30b, i.e. between the upper surface of the workpiece 30b and the lower surface of the workpiece 30a. In a plan view of the workpieces 30a, 30b, in particular in a plan view of the upper surface of the workpiece 30a or a plan view of the lower surface of the workpiece 30b, it cannot be seen whether there is a gap between the workpieces 30a, 30b.

As shown in FIG. 2, the sensor module 20 preferably includes a plurality of detectors or sensors D1, D2, D3 configured to detect various parameters, such as an intensity, of the process radiation 11 and to output a measurement signal based thereon. Each of the detectors D1, D2, D3 may comprise a photodiode or a photodiode or pixel array. The detectors preferably include a photodiode or a sensor for the visible spectral range, a photodiode or a sensor for the infrared spectral range and a photodiode or a sensor for a wavelength range of the laser beam or the radiated pilot laser beam or the radiated LED light. Furthermore, the sensor module 20 may include a plurality of beam splitters 221, 222 in order to split the process radiation 11 and to direct it to the corresponding detectors D1, D2, D3. The beam splitters 221, 222 may be configured as partially transparent mirrors and may be wavelength-selective according to embodiments.

The control unit 40 is connected to the sensor module 20 and receives the measurement signals from the detectors D1, D2, D3. The control unit 40 may be configured to record the measurement signals from the detectors D1, D2, D3. The control unit 40 is configured to determine and/or analyze a machining result of the laser machining and is in particular configured to analyze welded joints. The control unit 40 may be further configured to control the laser machining device 10 based on a result of the analysis.

The laser machining system 1 may be configured to carry out laser machining processes, in particular laser welding, and to carry out methods for analyzing a welded connection during laser welding of workpieces according to embodiments of the present disclosure.

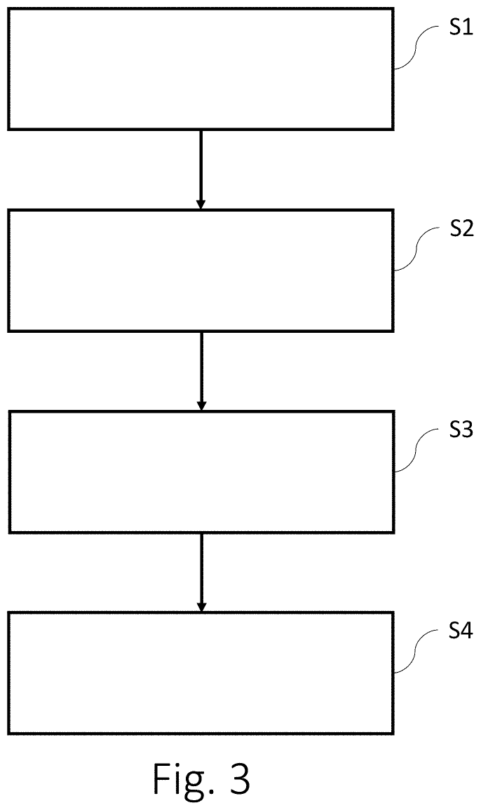

FIG. 3 shows a flowchart of a method of analyzing a welded connection during laser welding of workpieces according to embodiments of the present disclosure.

The method starts by acquiring a first measurement signal for a process radiation generated during laser welding (step S1). The method further includes acquiring a second measurement signal for radiation reflected by the workpieces (step S2). According to embodiments, acquiring the first measurement signal and acquiring the second measurement signal may be carried out simultaneously. Subsequently, it is determined based on the first measurement signal whether there is a gap between the workpieces (step S3). When it is determined that there is a gap, it is determined on the basis of the second measurement signal whether there is a welded connection or gap bridging between the two workpieces (step S4). In other words, it is determined whether there is electrical or mechanical contact between the workpieces.

Therefore, the method makes it possible to detect whether there is a gap between the connected workpieces. The method also makes it possible to identify whether there is a gap bridging, i.e. a welded connection, in particular an electrical and mechanical welded connection. In particular, the method may be used to analyze a welded electrical connection, for example to recognize a lack of electrical contact between joined workpieces. It is therefore possible to distinguish between a proper weld, i.e. a weld without a gap, also referred to as “good weld” or “0 gap weld”, or a weld with a gap and with gap bridging so that an electrical contact between the joined workpieces exists, or a weld with a gap but no gap bridging so that there is no electrical contact between the joined workpieces.

The first measurement signal is preferably acquired in two different wavelength ranges. For example, the first measurement signal may be acquired based on a detection of radiation intensity of the process radiation in a first wavelength range above the wavelength of the reflected radiation or above the wavelength of the laser beam used for laser welding, in particular in an infrared range, and on a detection of radiation intensity of the process radiation in a second wavelength range below the wavelength of the reflected radiation or below the wavelength of the laser beam, especially in a visible range. The first measurement signal acquired in the first wavelength range may correspond to thermal radiation and may be referred to as a “thermal signal”. The first measurement signal acquired in the second wavelength range may correspond to a plasma radiation and may be referred to as a “plasma signal”. However, it is also possible to acquire or evaluate only the first measurement signal in only one of these wavelength ranges. As mentioned above, the reflected radiation may include reflected laser radiation of a radiated pilot laser beam or reflected laser radiation of the (machining) laser beam used for the welding process or reflected laser radiation of a radiated LED light.

In the exemplary embodiment of FIGS. 1 and 2, the plasma signal may be acquired by the detector 1, which is sensitive in a wavelength range below the wavelength of the reflected radiation or the laser beam, in particular in the visible wavelength range of light, in order to detect the intensity of plasma process emissions. The thermal signal may be acquired by the detector D2, which is sensitive in a wavelength range above the wavelength of the reflected radiation or the laser beam, in particular in an infrared wavelength range of the light, in order to detect the intensity of process emissions in the infrared or thermal spectral range, i.e. of thermal radiation. The second measurement signal may be acquired by the detector D3, which is sensitive in the wavelength range of the reflected radiation or the laser beam, in order to detect back reflections of the laser of the laser machining device.

According to embodiments, determining whether there is a gap between the workpieces (step S3) may include taking a first integral over the plasma signal and taking a second integral over the thermal signal. In this case, it may be determined that there is a gap between the workpieces when the first integral falls below a predetermined first integral limit value and/or when the second integral falls below a predetermined second integral limit value.

According to embodiments, the determination of whether there is a welded connection or a gap bridging (step S4) may be based on a noise of the second measurement signal. In this case, it may be determined that there is no welded connection or no gap bridging when an outlier frequency of the noise of the second measurement signal exceeds a predetermined first noise limit value and/or when an integral over the noise of the second measurement signal exceeds a predetermined second noise limit value. The noise may be defined as a deviation from a mean value of the second measurement signal, preferably in a predetermined time interval or measurement signal, and in particular amplified by a predetermined factor. The mean value may be predetermined or may be determined based on the second measurement signal.

According to embodiments, at least one of the steps S1 to S4 may be carried out during the laser welding of the welded connection.

Preferably, one of the workpieces includes a battery, a battery module and/or a battery cell and another one of the workpieces includes a diverter. In this case, the method according to embodiments of the present disclosure may be used to analyze a welded electrical contact between the diverter and the battery, the battery module or the battery cell. In particular, one of the workpieces may consist of aluminum and another one of the workpieces may comprise copper and be coated with nickel. The coating may be applied galvanically. At least one of the workpieces may have a thickness of 0.10 mm to 0.50 mm, preferably a thickness of 0.15 mm to 0.35 mm, particularly preferably a thickness of 0.20 mm to 0.30 mm.

In an embodiment, diverters from two or more batteries are welded or contacted to one another. The diverters may be made of copper Cu or aluminum Al. In particular, a diverter of a first battery may be made of aluminum or copper and a diverter of a second battery may be made of aluminum or copper, so that the welded connection is formed between aluminum and aluminum Al—Al, or between copper and copper Cu—Cu, or between aluminum and copper Al—Cu.

Laser welding may include gas-tight welding of cell housings of battery cells, welding membranes of cell lids of battery cells, welding connections in the cell covers of battery cells and welding a bursting plate of cell lids of battery cells.

In particular, the method according to embodiments of the present disclosure may be used for analyzing a welded connection during laser welding of workpieces in lap or parallel joints, and in particular in I-weld seams.

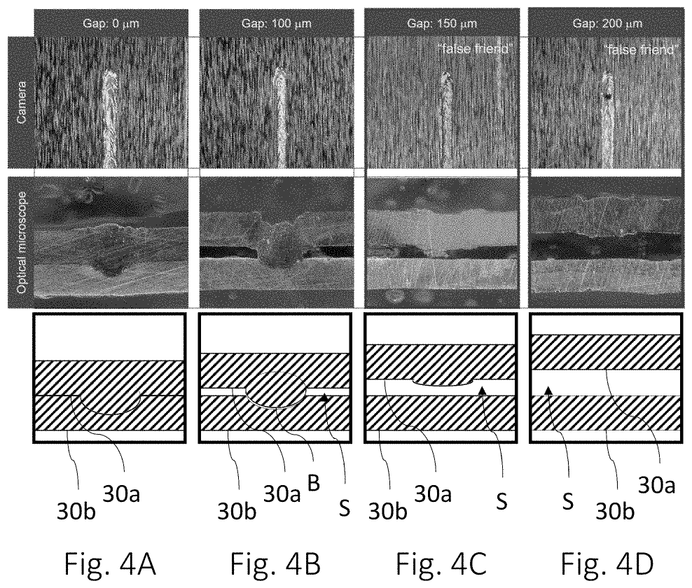

FIGS. 4A-4D show welded connections analyzed with a method of analyzing a welded connection during laser welding of workpieces according to embodiments of the present disclosure.

FIGS. 4A-4D each show a top view of I-weld seams created during laser welding in lap joint in the upper row (“camera”) and each show a sectional view of the respective weld seam in the middle row. A schematic view of the sectional view is shown in each case in the bottom row. In the plan view of the respective workpieces 30a, 30b or the respective weld seams, it is not possible to distinguish whether there is a weld without a gap, a weld with a gap and gap bridging, or a weld with a gap but without gap bridging. The plan view is of the upper surface of workpiece 30a as discussed with reference to FIG. 1.

In the first column (“Gap: 0 μm”), FIG. 4A shows a proper weld seam, also referred to as a “good weld”, which was recognized using the method of analyzing welded connections during laser welding of workpieces according to embodiments of the present disclosure. The welded workpieces 30a, 30b, shown here as metal sheets, have no gap between them and current can flow via the weld seam. The resulting welded connection is marked as “good weld” or “0-gap”.

FIGS. 4B-4D show typical defect patterns recognized using the method of analyzing welded connections during laser welding of workpieces according to embodiments of the present disclosure.

FIG. 4B shows a gap S between the two welded workpieces 30a, 30b in the second column (“gap: 100 μm”). This gap S can be tolerated because the gap S is bridged (gap bridging “B” in FIG. 4B). Thus, despite the existing gap S, there is still electrical contact between the welded workpieces, i.e. there is a welded connection. This is also referred to as “welding with gap bridging” or “gap with (electrical) connection or (electrical) contact”.

In the third and fourth columns (“Gap: 150 μm” and “Gap: 200 μm”), FIGS. 4C and 4B show another typical defect pattern, also referred to as “false friend”. There is a gap S between the welded workpieces 30a, 30b that is not bridged so that there is no electrical contact between the workpieces. This is also referred to as “welding without gap bridging” “gap without (electrical) connection or (electrical) contact”. That is, there is no welded connection.

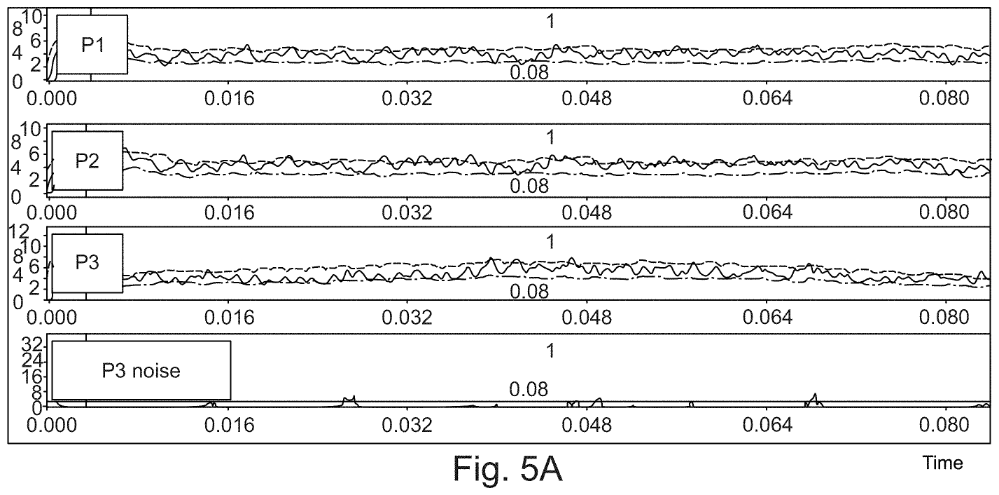

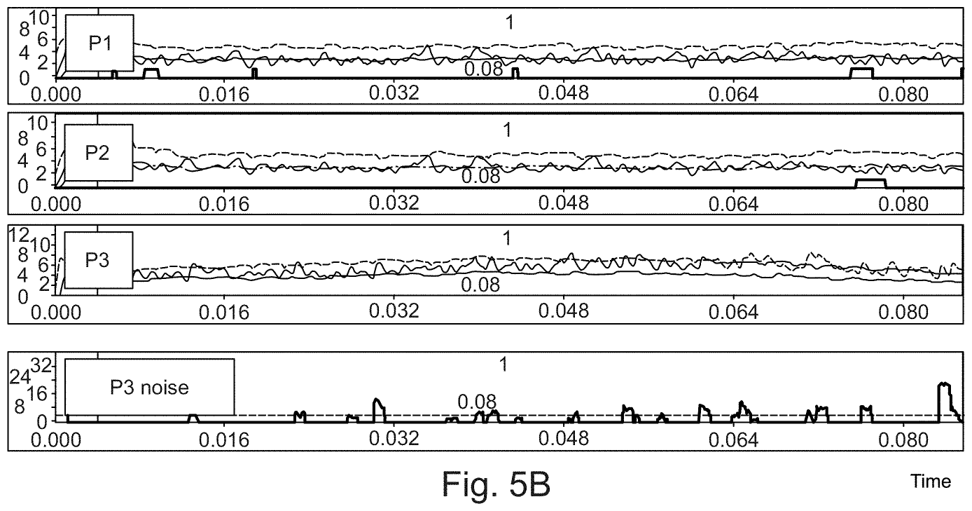

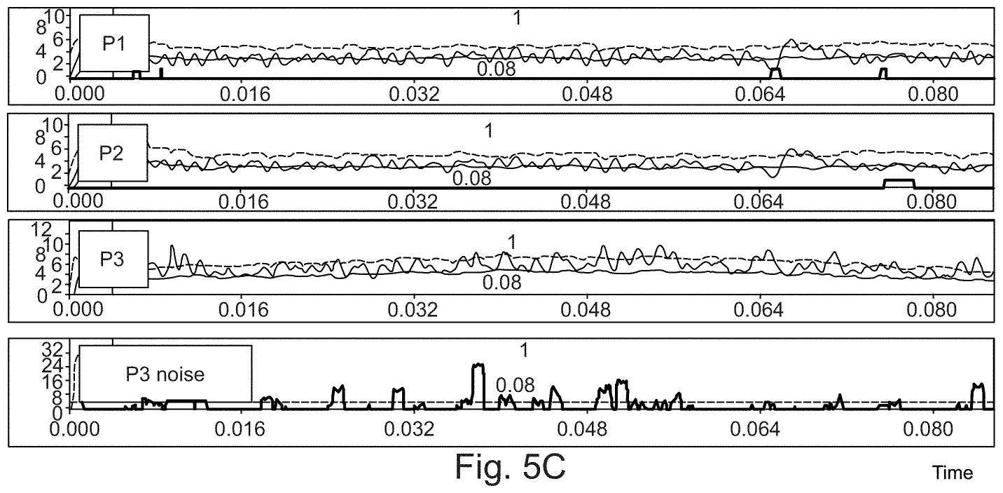

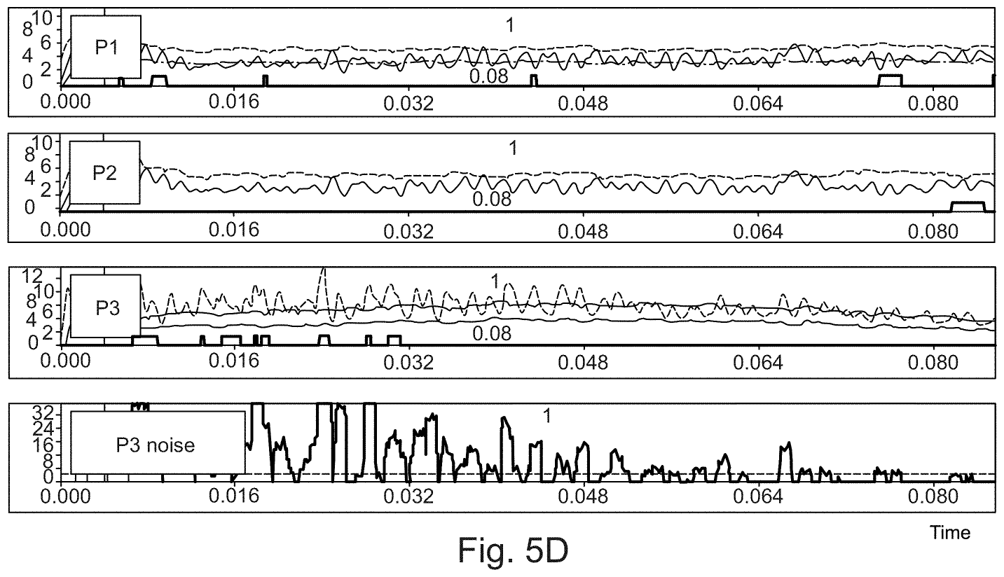

FIGS. 5A to 5D show examples of time curves of measurement signals acquired by a method of analyzing a welded connection during laser welding of workpieces according to embodiments.

In the embodiment shown in FIGS. 5A to 5D, the first measurement signal was acquired in the first and in the second wavelength range and includes the plasma signal P1 and the temperature signal P2. The second measurement signal for the reflected laser light is referred to as the back reflection signal P3. FIGS. 5A-5D show exemplary curves of the measurement signals P1, P2 and P3, each for one laser welding process. In addition, the curve of noise of the measurement signal P3 is shown as “P3 noise”.

The method according to embodiments of the present disclosure includes acquiring the plasma signal P1 and the temperature signal P2. It is determined that there is a gap between the workpieces when, for example, the plasma signal P1 and/or the temperature signal P2 falls, i.e. lies at or below or falls below a respective lower envelope. This may be determined, for example, by taking a first integral over the plasma signal P1 and a second integral over the temperature signal P2. When the first integral falls below a predetermined first integral limit value and/or when the second integral falls below a predetermined second integral limit value, a gap exists. When a gap exists, it is determined based on the back reflection signal P3 whether there is a welded connection or gap bridging. There is no welded connection or gap bridging when an outlier frequency of the noise of the back reflection signal P3 exceeds a predetermined first noise limit value and/or when an integral over the noise of the back reflection signal P3 exceeds a predetermined second noise limit value. Otherwise there is a gap with gap bridging, i.e. a welded connection.

On the one hand, the method may be used to distinguish between good welds, i.e. welds without a gap between the workpieces, and welds with a gap. On the other hand, the method can distinguish between welds with a gap but with gap bridging and welds with a gap but without gap bridging.

In FIG. 5A, the integrals of the plasma signal P1 and the temperature signal P2 exceed the respective limit values. The weld created during the laser welding process is marked as “good weld”. A welded connection with a 0 gap is present between the workpieces joined in this way. In particular, there is an electrical contact or an electrical connection between the connected workpieces. This corresponds to the welded connection shown in FIG. 4A.

In FIGS. 5B-5D, the plasma signal P1 and the thermal signal P2 have fallen relative to the respective predetermined reference values or envelope curves. In other words, the integrals of the plasma signal P1 and of the thermal signal P2 fall below the respective limit values. The welds created during the respective laser welding processes are marked as welds with a gap.

According to embodiments, it is sufficient when either the integral of the plasma signal P1 or the integral of the temperature signal P2 falls below the respective limit value. According to further embodiments, it may be determined that a gap is only present when both the integral of the plasma signal P1 and the integral of the temperature signal P2 fall below the respective limit value.

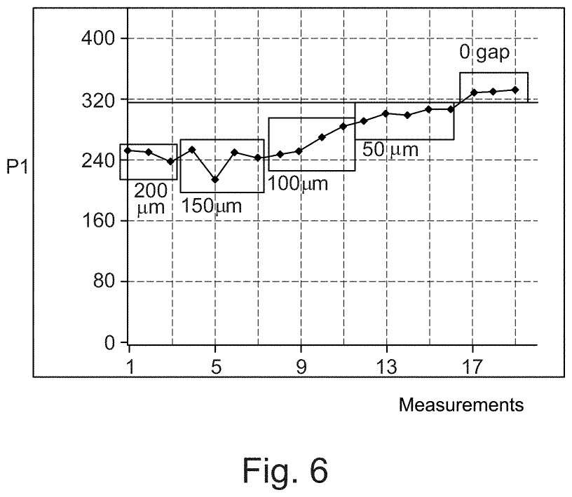

In FIG. 5B, there is a gap of 100 μm between the workpieces, in FIG. 5C there is a gap of 150 μm between the workpieces, and in FIG. 5D there is a gap of 200 μm between the workpieces. The welds shown in FIGS. 5B-5D correspond to the welds shown in FIGS. 4B-4D. The gap width may be determined based on the integral value of the plasma signal P1 and/or the thermal signal P2. When the integral value is in a first range, a gap width of a first value or range of values may be assigned to the corresponding weld. Correspondingly, an integral value that lies in a second range may be assigned a gap width of a second value or range of values, etc. This is illustrated by way of example in FIG. 6 for the plasma signal P1.

For the corresponding welds in FIGS. 5B-5D, it is now determined whether there is nevertheless a welded connection between the workpieces and, accordingly, an electrical contact or an electrical connection. For this purpose, the noise of the back reflection signal P3, P3 noise, is analyzed.

In FIG. 5B, an outlier frequency of the noise of the rear reflection signal P3 is below a predetermined first noise limit value. Therefore, it is determined that, despite the existing gap, there is a weld connection between the workpieces or a gap bridging.

In FIGS. 5C and 5D, an outlier frequency of the noise of the back reflection signal P3 is greater than the predetermined first noise limit value. It is therefore determined that there is no welded connection or gap bridging, and thus no electrical contact, between the workpieces.

The present invention is based on the finding that in laser welding in lap joint, a good weld can be distinguished from welds with a gap by a drop of the intensity of a plasma signal and a drop of the intensity of a thermal signal of the laser welding process. Furthermore, the present invention is based on the finding that a weld with a gap and with gap bridging can be distinguished from a weld with a gap but without gap bridging by a significant increase of the noise of a back reflection signal of the radiation reflected back from the workpieces in the latter case. Accordingly, a combination of the plasma signal and the thermal signal with the back reflection signal provides unambiguous information about the presence or absence of a welded connection, in particular an electrical contact, between the workpieces. Here “gap is present” may be considered as a necessary condition, and excessive noise as a sufficient condition for the gap not being bridged. Accordingly, it can be recognized unambiguously whether a false friend is present.

1. A method of analyzing a welded connection during laser welding of workpieces, said method comprising:
acquiring a first measurement signal for a process radiation generated during laser welding;
acquiring a second measurement signal for a radiation reflected by the workpieces;
determining based on said first measurement signal whether there is a gap between the workpieces; and
when it is determined that there is a gap, determining based on said second measurement signal whether there is a welded connection.

2. The method according to claim 1, wherein the reflected radiation comprises at least one of: reflected laser radiation of the machining laser beam, reflected radiation of LED light radiated into a machining area, and reflected laser radiation of a pilot laser beam radiated into a machining area.

3. The method according to claim 1, wherein said first measurement signal and/or second measurement signal is based on a detection of a radiation intensity.

4. The method according to claim 1, wherein said first measurement signal is acquired in a first wavelength range above a wavelength of a machining laser beam used for laser welding and/or above a wavelength of the reflected radiation; and/or
wherein said first measurement signal is acquired in a second wavelength range below the wavelength of the machining laser beam used for laser welding and/or below the wavelength of the reflected radiation.

5. The method according to claim 1, wherein the process radiation acquired as said first measurement signal is thermal radiation in an infrared spectral range and/or plasma radiation in a visible spectral range.

6. The method according to claim 1, wherein the reflected radiation acquired as said second measurement signal is in an infrared spectral range or in a visible green or blue spectral range.

7. The method according to claim 1, wherein determining whether there is a gap between the workpieces comprises determining a gap width based on the first measurement signal, and
wherein it is determined that there is a gap when the gap width is greater than a predetermined gap width limit value.

8. The method according to claim 1, wherein determining whether there is a gap between the workpieces comprises determining whether said first measurement signal is or falls below a reference value or a reference curve,
wherein it is determined that there is a gap between the workpieces when said measurement signal is or falls below the reference value or the reference curve.

9. The method according to claim 1, wherein determining whether there is a gap between the workpieces comprises taking a first integral over said first measurement signal and/or a first mean value of said first measurement signal,
wherein it is determined that there is a gap between the workpieces when the first integral falls below a predetermined first integral limit value and/or when the first mean value falls below a predetermined first mean value limit value.

10. The method according to claim 1, wherein said first measurement signal is acquired in a first wavelength range above a wavelength of the reflected radiation or above a wavelength of a machining laser beam used for laser welding and in a second wavelength range below the wavelength of the reflected radiation or below the wavelength of the machining laser beam used for laser welding, and determining whether there is a gap between the workpieces comprises taking a first integral over the first measurement signal acquired in the first wavelength range and taking a second integral over the first measurement signal acquired in the second wavelength range; and
wherein it is determined that there is a gap between the workpieces when the first integral falls below a predetermined first integral limit value and/or when the second integral falls below a predetermined second integral limit value.

11. The method according to claim 1, wherein the determining wherein there is a welded connection comprises determining based on a noise of said second measurement signal whether there is a welded connection.

12. The method according to claim 11, wherein it is determined that there is no welded connection,
when an outlier frequency of the noise of said second measurement signal exceeds a predetermined first noise limit value; and/or
when an integral over the noise of said second measurement signal exceeds a predetermined second noise limit.

13. The method according to claim 1, wherein at least one of the workpieces comprises or consists of aluminum and/or copper and/or nickel.

14. The method according to claim 1, wherein at least one of the workpieces has a thickness of 0.10 mm to 0.50 mm, or 0.15 mm to 0.35 mm, or 0.20 mm to 0.30 mm.

15. The method according to claim 1, wherein the workpieces comprise a diverter of a first battery and a diverter of a second battery, and wherein a welded electrical contact between the diverters of the batteries is analyzed as the welded connection.

16. The method according to claim 1, wherein the workpieces are arranged in a lap joint or parallel joint during laser welding.

17. A method for laser welding a first workpiece and a second workpiece, said method comprising the steps of:
arranging the workpieces such that a first surface of the first workpiece and a first surface of the second workpiece lie on top of each other;
laser welding the workpieces to form a welded connection between the workpieces by radiating a machining laser beam onto a second surface of said first workpiece, said second surface of said first workpiece being opposite said first surface of said first workpiece, and/or by radiating a machining laser beam onto a second surface of said second workpiece, said second surface of said second workpiece being opposite said first surface of said second workpiece;
performing the method of analyzing the welded connection according to claim 1.

18. The method according to claim 17, wherein the workpieces are arranged in a lap joint or parallel joint.

19. The method according to claim 17, wherein the first surfaces of the workpieces touch in at least one region and/or wherein a gap is present in another region between the first surfaces of the workpieces.
